(19) United States
(12) Patent Application Publication
(10) Pub. No.: US 2025/0114687 A1
(43) Pub. Date: Apr. 10, 2025

(54) TOWING DEVICE FOR A USER TO PULL A TRAILER

(71) Applicant: Thule Sweden AB, Hillerstorp (SE)

(72) Inventors: Niclas Tjäderborn, Vaggeryd (SE); Hannes Falk, Ulricehamn (SE); Urban Stark, Vaggeryd (SE)

(21) Appl. No.: 18/906,578

(22) Filed: Oct. 4, 2024

(30) Foreign Application Priority Data
Oct. 6, 2023 (DE) 202023105796.9

(51) Int. Cl. A63C 11/00; B62B 15/00

(52) U.S. Cl. CPC A63C 11/00; B62B 15/007

(57) ABSTRACT

A trailer towing device includes a spring device and a locking device. The locking device is configured to move between a locking state in which the spring device is blocked and a release state.

### TECHNICAL FIELD

The present invention relates to a pulling device for a trailer in order for a user, in particular a cross-country skier, to pull the trailer. Furthermore, the present invention relates to a trailer.

### BACKGROUND

Trailers are used by users for various activities, such as transporting luggage, shopping, or a child. For example, such trailers are pulled by a bicycle. However, trailers can also be used for other activities, for example sports such as jogging or cross-country skiing. The user usually pulls the trailer behind them. It is important that the trailer is comfortable for the user. In addition, a pulling device should enable sufficient control of the trailer for the chosen sport.

### SUMMARY

A first aspect relates to a pulling device for a trailer. The trailer can be designed to transport luggage, shopping, or a child, for example. The trailer can, for example, have wheels, runners or skis on which the trailer can be pulled across a surface. The trailer can, for example, be designed as a stroller. The trailer may have a frame structure that retains the wheels, runners or skis and connects them to the pulling device. The pulling device can be fastened to the front of the trailer, optionally in an articulated manner or so as to be changeable and/or detachable. The trailer can, for example, have a transport device which forms, for example, a transport surface or a child seat. The transport device can be held by the frame structure. The pulling device can be designed for the trailer to be pulled by a user. The pulling device can, for example, have a pulling harness on a side facing away from the rest of the trailer and/or at a free end, by means of which harness the pulling device and thus also the trailer can be fastened to the user. The user can, for example, be a cross-country skier or jogger. The pulling device can allow the user to move relative to the trailer when pulling it so as not to overly restrict freedom of movement for a sporting activity. For example, the pulling harness can be rotatably held so that the user can turn their shoulders to support themselves using poles.

The pulling device has a spring device. The spring device can provide cushioning and/or damping in the pulling device. For example, the connection from the trailer to the user can thus be dampened and/or spring-loaded. This can increase comfort when pulling the trailer during certain types of use.

The pulling device has a locking device. The locking device can move between a locking state, in which the spring device is blocked, and a release state. In the release state, for example, the spring device is released. In the locking state, the pulling device may not be spring-loaded and/or damped. For example, this results in a connection between the user and the trailer that is at least longitudinally rigid. The locking state can block a change in the length of the pulling device and/or the cushioning of the pulling device. The locking device can be movable by a user, for example by pressing an actuating element. The actuating element can be designed to be actuable even when wearing gloves. The actuating element can, for example, be designed as a pushbutton or a movable sleeve. The actuating element can be formed by a locking element which, in the locking state, engages with a first rod element and/or a second rod element, which will be explained in more detail below. For example, the pulling device can have two modes. In the locking state, the pulling device may not be spring-loaded. The connection from the user to the trailer is then rigid, for example. In the release state, the pulling device can be spring-loaded. The connection from the user to the trailer can then be spring-loaded.

The locking device allows the user to adapt the pulling device to their personal preferences and/or to a chosen sport. For example, a rigid connection may be desirable in order to be able to pull the trailer as efficiently as possible and/or to be able to precisely control it when pulling. For example, a spring-loaded connection may be desirable in order to be able to pull the trailer comfortably and/or efficiently on uneven terrain. For example, if the user is a cross-country skier with a classic cross-country skiing style, a spring-loaded connection to the trailer may be preferred. For example, if the user is a cross-country skier with a skating cross-country skiing style, a non-spring-loaded connection to the trailer may be preferred. The pulling device can thus be used flexibly for different sports and adapted to user preferences.

In a further embodiment of the pulling device, the pulling device has a first rod element and a second rod element. The first rod element is mounted on the second rod element so as to be axially movable and spring-loaded by means of the spring device. The first rod element can thus, for example, be moved along its longitudinal extent relative to the second rod element. For example, the first rod element is partially arranged within the second rod element and at least regions thereof can move axially into the second rod element or axially out of the rod element when the pulling harness is worn. Spring-loaded mounting can have a neutral position. For example, the first rod element is held in a certain position relative to the second rod element by the spring device. If a tensile load is applied, the first rod element can be pulled out of the second rod element. If the tensile load decreases and/or a pressure load occurs, the first rod element is then pulled and/or pushed back into the second rod element. This may result in a spring-loaded pulling device. This softens the impact on the user, for example. Even uneven pulling and/or changing resistances when pulling the trailer can thus be at least partially compensated for.

The locking device can be designed to axially fix the first rod element to the second rod element in the locking state. In the release state, the first rod element may be axially movable relative to the second rod element. Any range of axial movement of the two rod elements relative to one another can be limited by end stops. The release state can release the axial movement. The locking state can block axial movement. The locking element or actuating element can be designed to engage with the first rod element and/or the second rod element in the locking state.

The spring device can, for example, have a spring element and/or a damping element. For example, the spring device may have an air spring or a coil spring. The spring device can, for example, have a hydraulic damper. The spring element can be held on a rod of the first rod element by a bearing element, which is designed, for example, as a sleeve. The spring element can be fastened at one end to the first rod element and at an end opposite thereto to the second rod element. The spring device can be designed to dampen an axial relative movement between the two rod elements.

The rod elements can, for example, be designed as metal rods or have such rods, such as aluminum rods. The rod elements can have a round or square cross section. The rod elements can, for example, be designed as hollow profiles. For example, the second rod element can be designed as a hollow aluminum profile having a rectangular cross section. The first rod element can, for example, have a round bar. The rod elements may have further elements, for example for fastening to one another and/or for mounting parts of the spring device. The mounting for the spring device can also form part of the spring device. The two rod elements can, for example, be straight or curved. At least in an axial portion in which the two rod elements are arranged one inside the other, the axial extension of the two rod elements can be the same shape. The two rod elements can form a telescopic pulling device, the change in length of which provides the cushioning.

In a further embodiment of the pulling device, the locking device has a locking element. The locking element can be designed to axially fix the two rod elements to one another, for example by jointly engaging with the two rod elements. The locking element can be held on the second rod element so as to move between a locking position in which the locking element engages with the first rod element and a release position. In the release position, for example, at least the engagement with the first rod element and/or the second rod element can be released. For example, the locking element can be movably mounted either directly or indirectly on the second rod element. The locking element can, for example, be designed as a plastics component or a metal component. The locking element can, for example, be designed to be gripped by a hand wearing a winter glove. The locking element can, for example, be movable by a user between its two positions. The locking element can be movable in a direction that is transverse to an axial direction of the first rod element, in particular orthogonally thereto. The locking element may then be easy and intuitive to use. The locking element can envelope the first rod element and/or the second rod element, at least in regions.

In a further embodiment of the pulling device, the locking device has a retaining element by means of which the locking element is held on the second rod element so as to be axially fixed in position. This allows the locking element to be easily mounted on the second rod element. Therefore, the rod element itself can, for example, be a standard component. The retaining element can, for example, provide a guide for the locking element. The retaining element can be designed as a plastics component or a metal component. The retaining element can surround the first rod element and/or the second rod element, at least in regions.

In a further embodiment of the pulling device, the locking device is designed to provide a first latched position for the locking element when in its locking position. Alternatively or additionally, the locking device can be designed to provide a second latched position for the locking element when in its release position. A locking position can, for example, be a position in which a greater actuating force is required to move the locking element than in other positions. For example, in addition to friction, the locking element can be held in a latched position by a positive fit. The latched position can also have a stop which limits the mobility of the locking element in a direction that is transverse to an axial direction of the first rod element. Each of the latched positions allow a user to identify when the locking position and/or the release position has been reached. The locking device can therefore be particularly simple and intuitive to use. For example, a latched position can be formed by a groove and a corresponding projection. A groove can be formed, for example, on the second rod element or the retaining element for each latched position. The locking element can have a single projection which engages in the associated groove in the corresponding latched positions. However, multiple grooves and projections can also be provided, which are engaged in a latched position. This means that a retaining force can be particularly high in the latched position. The latched position can retain the locking element in position and help prevent unwanted movement.

The locking device can be designed to generate a sound when the locking element reaches the latched position. The sound may be, for example, an audible clicking and/or latching sound. This makes it particularly obvious to the user when this position has been reached.

In a further embodiment of the pulling device, the locking device has a damping element which engages with the first rod in the locking position. The damping element can, for example, be softer and/or more resilient than the locking element. The damping element can be made of TPE, for example. There may be some play when it engages with the first rod element. When pulling the trailer, the first rod element may thus still have slight axial movement relative to the second rod element and thus the locking element. The damping element can prevent or at least reduce noise caused by such movement and by engagement of the first rod element. The damping element can be held on the locking element on a side of the locking element that faces the first rod element. The locking element can only engage with the first rod element in the locking position by means of the damping element. For example, the locking element has no contact with the first rod element in both of its positions. In another embodiment, the locking element engages directly with the first rod element.

In a further embodiment of the pulling device, the retaining element forms a guide for the locking element. The guide can be formed, for example, by walls and/or projections extending on the outside of the retaining element in the circumferential direction. For example, the retaining element can have laterally projecting walls which guide the locking element in a direction that is transverse to an axial direction of the first rod element. The locking element can be arranged between two walls which, for example, are axially spaced apart and/or extend in parallel with one another. In the locking position, an actuating side of the locking element can be aligned with the guide so as to be flush therewith. This makes the locking position particularly easy to identify. In the release position, the locking element can be flush with the guide with one actuating side. This makes the release position particularly easy to identify. The actuating sides can, for example, extend in parallel with a side of the second rod element and/or with the axial extension of the second rod element. The actuating side for moving the locking element into the release position, in particular by pressing, can be arranged opposite the actuating side for moving the locking element into the locking position, in particular by pressing. In addition, the guide can thus prevent unwanted actuation of the locking device, for example by an obstacle pressing on the locking element when pulling the trailer. The flush connection to the guide can be achieved, for example, by the axially extending side of the locking element that is furthest away from the second rod element in the corresponding position and/or a side of the locking element which must be pressed in order to move the locking element to its other position.

In a further embodiment of the pulling device, the locking element is made up of two parts. This makes the locking element particularly easy to install. The two parts of the locking element can be connected to one another by a snap-fit connection. Alternatively, the two parts can also be glued or welded together, for example. The two parts can each form a half shell. The two parts of the locking element can collectively envelope the second rod element and/or the retaining element.

In a further embodiment of the pulling device, the retaining element is made up of two parts. This makes the retaining element particularly easy to install. The two parts of the retaining element can be connected to one another by a snap-fit connection. Alternatively, the two parts can also be glued or welded together, for example. The two parts can each form a half shell. The two parts of the retaining element can collectively envelope the second rod element.

The retaining element can, for example, rest on the second rod element. The retaining element can, for example, be immovably fixed to the second rod element. The locking element can, for example, rest on the retaining element. If, for example, no retaining element is provided, the locking element can also rest on the second rod element. The locking element can be mounted such that it cannot move axially on the second rod element and/or the retaining element.

In a further embodiment of the pulling device, the locking device is held at a through-opening of the second rod element. The through-opening can be formed in a wall of the second rod element, for example if the second rod element is designed as a hollow profile. The through-opening can be a lateral through-opening. When the first rod element is in its neutral position, for example, the through-opening can be located in an engagement region of the first rod element so that the locking element blocks the axial mobility of the first rod element.

For example, the locking device can be held at the through-opening of the second rod element by the locking element protruding at least partially into the through-opening of the second rod element in both the engagement position and the release position. Alternatively or additionally, the locking device can be held at the through-opening of the second rod element by the retaining element having a projection which projects into the through-opening of the second rod element. The projection of the retaining element can be designed to form a snap-fit connection with the second rod element. The locking device can thus be easily held in an interlocking manner. In a two-part design, the retaining element and/or the locking element can still be easily clipped onto the second rod element or into the through-opening.

In a further embodiment of the pulling device, the first rod element is held on the second rod element so as to be rotatable about its axial extent. This allows the pulling harness to rotate about a longitudinal axis of the pulling device, for example, which can enable particularly comfortable pulling. The first rod element can also be held on the second rod element so as to be further rotatable about its axial extent when the locking device is in its locking state. The locking state thus only blocks axial movement, for example. This means that there is no loss of comfort in the locking state. For example, the first rod element may have an engagement region which extends around a circumference of the first rod element. For example, the first rod element can have a circumferential groove in which the locking element engages. This blocks axial movement, but not rotation, relative to the second rod element.

In another embodiment, the locking device is designed to also block the first rod element from rotating relative to the second rod element. When the locking device is in the locking state, the first rod element can no longer be held on the second rod element so as to be rotatable about its axial extent. For example, the first rod element may be fully fixed to the second rod element in the locking state of the locking device.

In a further embodiment of the pulling device, the locking device is sealed, in particular against snow. For example, each of the components can directly abut one another for this purpose. For example, the through-opening in the second rod element can be sealed, in particular by the locking element arranged therein and/or the retaining element arranged therein. For example, a space between the retaining element and the locking element can be sealed. For example, depending on the position of the locking element, a space can be formed on two opposite sides between the locking element and the retaining element and/or the second rod element each time. This space can be limited, in a circumferential direction, radially outward by the locking element and radially inward by the second rod element or the retaining element. In the axial direction, the space can be limited, for example by the wall regions of the retaining element that form the guide, thus blocking access to the space. This means that little or no snow can enter here, which could block the locking element in the position it is in at the time.

A second aspect relates to a trailer. The trailer has a pulling device according to the first aspect. Advantages and further features can be found in the description of the first aspect, wherein embodiments of the first aspect also form embodiments of the second aspect, and vice versa. The trailer is designed to be pulled by a user, in particular a cross-country skier, using the pulling device.

### BRIEF DESCRIPTION OF THE DRAWINGS

FIG. 1 shows a schematic perspective view of a trailer.

FIG. 2 shows a schematic perspective view of a first embodiment of a pulling device of the trailer according to FIG. 1.

FIG. 3 shows a schematic sectional view of a locking device of the pulling device according to FIG. 1 in a release state.

FIG. 4 shows a schematic sectional view of the locking device of the pulling device according to FIG. 1 in a locking state.

FIG. 5 shows a further schematic sectional view of the locking device of the pulling device according to FIG. 1 in the release state.

FIG. 6 shows a further schematic sectional view of the locking device of the pulling device according to FIG. 1 in the locking state.

FIG. 7 shows an exploded view of parts of the pulling device according to FIG. 1.

FIG. 8 shows a further exploded view of parts of the pulling device according to FIG. 1.

FIG. 9 shows another exploded view of parts of the pulling device according to FIG. 1.

FIG. 10 shows a sectional exploded view of parts of the pulling device according to FIG. 1.

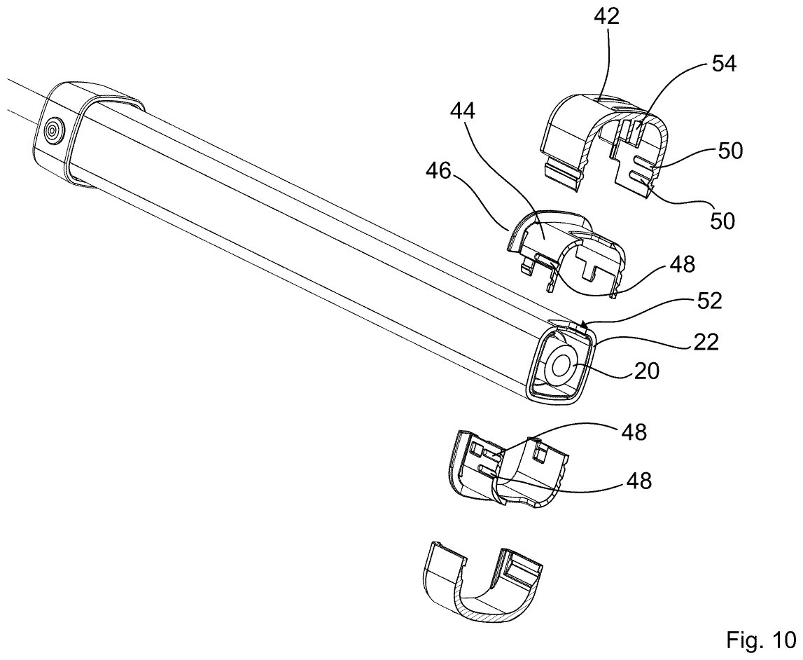

FIG. 11 shows a schematic partially transparent perspective view of a second embodiment of a pulling device of the trailer according to FIG. 1.

FIG. 12 shows a sectional exploded view of parts of the pulling device according to FIG. 11.

FIG. 13 shows a schematic sectional view of a locking device of the pulling device according to FIG. 11 in a locking state.

FIG. 14 shows a schematic sectional view of the locking device of the pulling device according to FIG. 1 in a release state.

### DETAILED DESCRIPTION

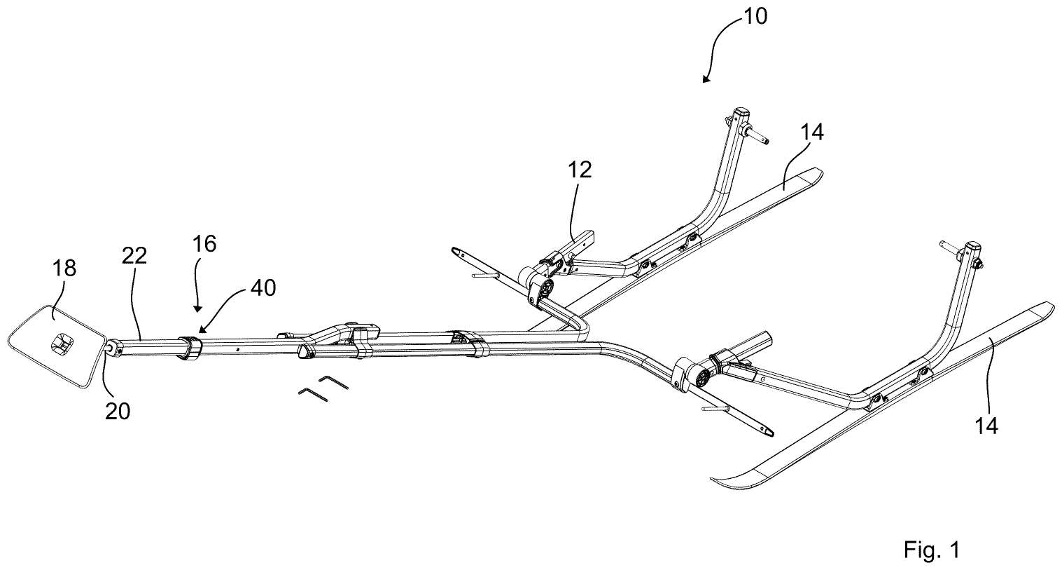

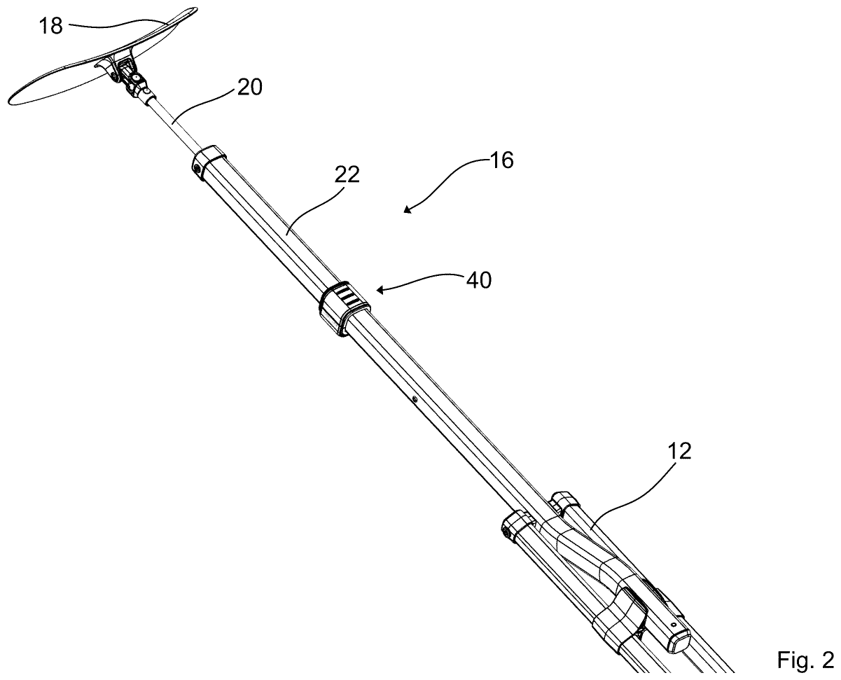

FIG. 1 is a schematic perspective view of a trailer 10. The trailer 10 has a frame structure 12 and two skis 14, by means of which the trailer 10 can be pulled over snow by a cross-country skier. A transport device (not shown) is held on the frame structure 12 and has, for example, a child seat. A pulling device 16 is rigidly connected to front of the frame structure 12. The pulling device 16 has a pulling harness at a free end facing away from the trailer 10, of which only a back plate 18 is shown. The pulling harness can, for example, additionally have shoulder straps and a waist strap. The pulling harness is looped around the user so that the user can pull the trailer 10 without having to use their hands. The back plate 18 is hingedly connected to the rest of the pulling device 16, as can be seen in FIG. 2.

The pulling device 16 is spring-loaded. For this purpose, the pulling device 16 has a first rod element 20, a second rod element 22 and a spring device 24, which is shown in detail in other figures. The first rod element 20 has a round bar which is at least partially arranged in the second rod element 22. The first rod element 20 is held on the second rod element 22 so as to be axially movable and spring-loaded by means of the spring device 24. The first rod element 20 can thus telescopically extend out of the second rod element 22 and also be retracted. At an end facing away from the second rod element 22, the first rod element 20 is hingedly connected to the back plate 18. The second rod element 22 is designed as a hollow rectangular profile.

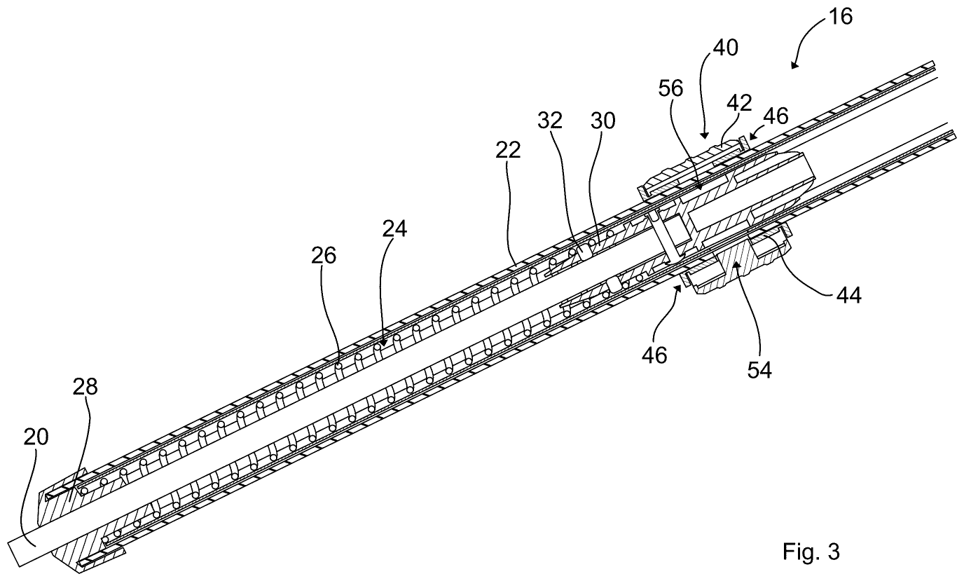

In FIG. 3, the pulling device 16 is shown in longitudinal section. The spring device 24 has a spring element 26 which is designed as a helical spring and is held in a sleeve of the second rod element 22. The spring element 26 is fastened to the second rod element 22 at an end that faces the pulling harness by means of a bearing element 28. The bearing element 28 forms a pin on which the spring element 26 is placed. The bearing element 28 thus seals the second rod element 22 at the end face. At an end facing away from the pulling harness, the spring element 26 is connected to the first rod element 20 by means of a further bearing element 30. The first rod element 20 has this bearing element 30, which is fixed to the round bar of the first rod element 20. The further bearing element 30 also forms a pin on which the spring element 26 is placed. The spring element 26 holds the first rod element 20 in an axial neutral position along the second rod element 22. Under tensile load, the first rod element 20 is pulled out of the second rod element 22. When a pressure load is applied, the first rod element 20 is pushed into the second rod element 22. The spring element 26 is thus compressed or stretched and thus provides a restoring force for the first rod element 20 in the direction of its neutral position. This provides cushioning. The first rod element 20 is mounted on the second rod element 22 so as to be rotatable about its longitudinal axis. To ensure that rotation does not result in tension in the spring element 26, said spring element 26 is also mounted around the bearing element 30 so as to be rotatable about the longitudinal axis. For this purpose, the spring device 24 has a guide 32 here.

However, such cushioning is not desired for all types of use. In a classic cross-country skiing style, such cushioning provided by the pulling device 16 is generally perceived to be comfortable. However, in a skating style of cross-country skiing, many users find such cushioning to be a hindrance.

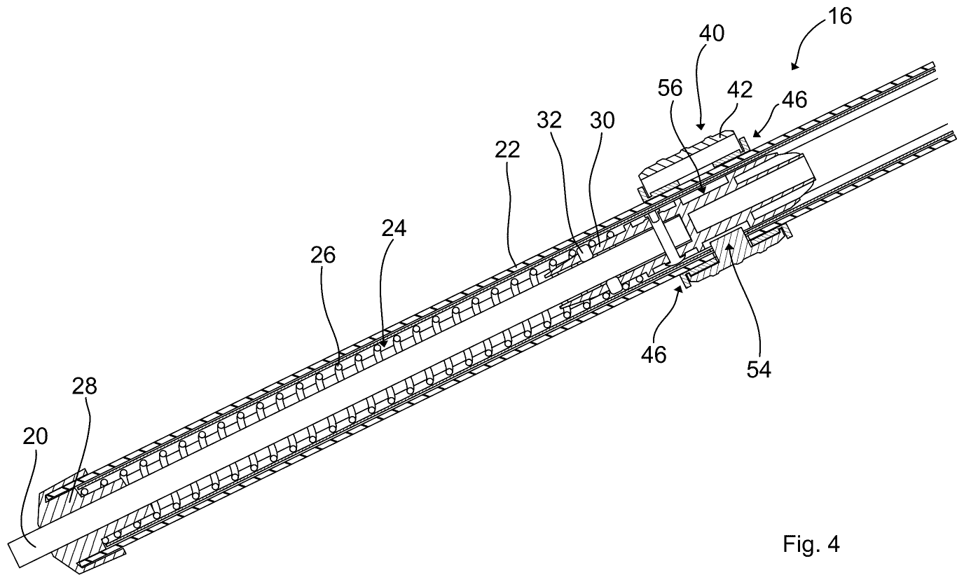

Therefore, the pulling device 16 has a locking device 40. The locking device 40 can move between a locking state in which the first rod element 20 is axially fixed to the second rod element 22, and a release state. For this purpose, the locking device 40 has a locking element 42 which is held on the second rod element 22 so as to be movable between a locking position, in which the locking element 42 engages with the first rod element 20, and a release position. The locking element 42 is held on the second rod element 22 so as to be movable in a direction that is orthogonal to an axial direction of the first rod element 20. In FIG. 3, the locking element 42 is in its release position. In the release position, the locking element 42 does not engage with the first rod element 20 and the first rod element 20 can move axially along the second rod element 22. In FIG. 4, the locking element 42 is in its locking position. In the locking position, the locking element 42 engages with the first rod element 20 and thus connects the first rod element 20 to the second rod element 22. The first rod element 20 can thus no longer move axially along the second rod element 22. The cushioning is therefore blocked.

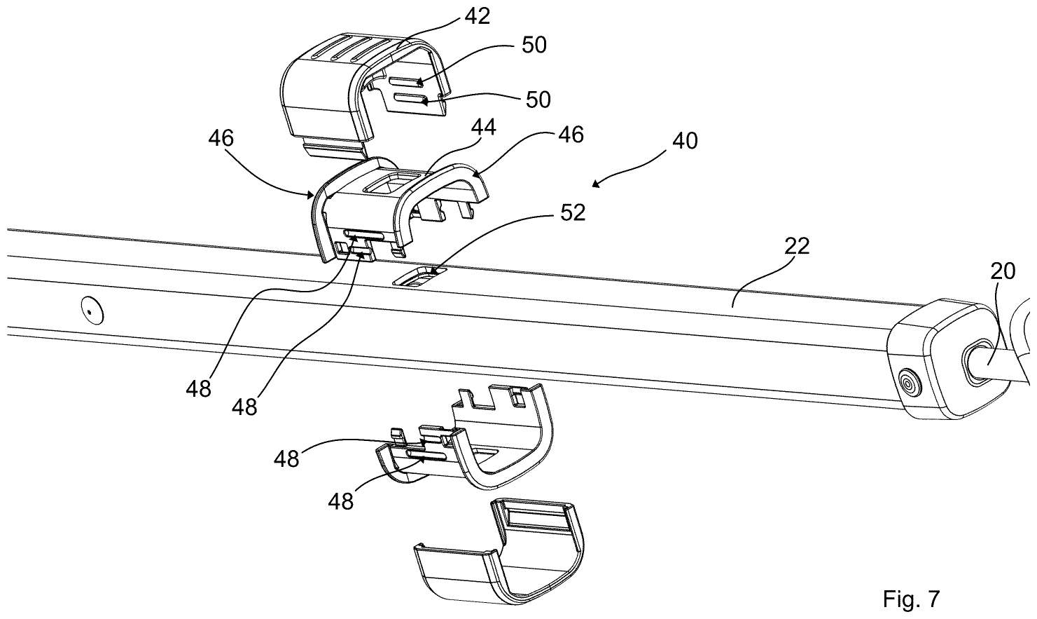

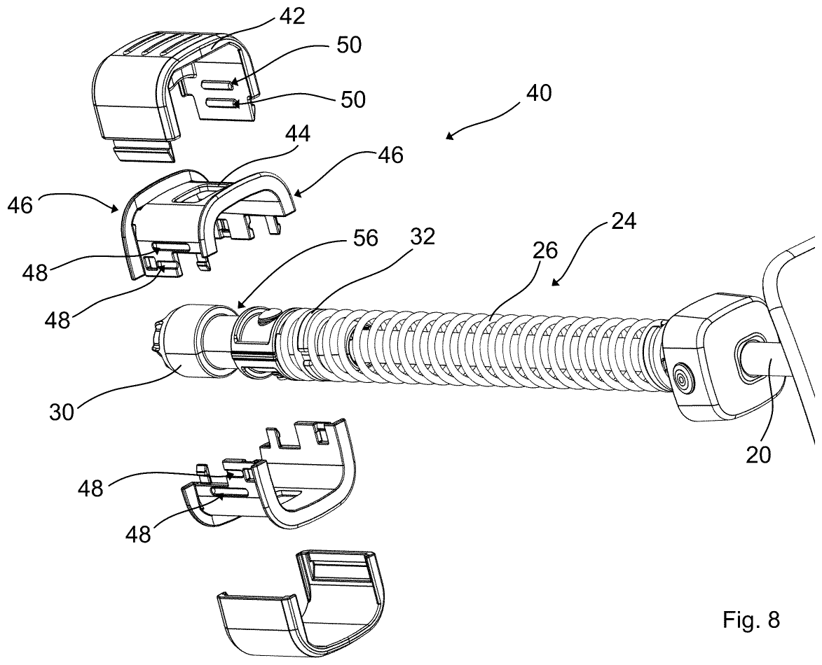

The locking device 40 has a retaining element 44, by means of which the locking element 42 is held on the second rod element 22 so as to be axially fixed in position. The retaining element 44 forms a guide for the locking element 42 through two circumferential walls 46 which are formed at axially opposite ends of the retaining element 44. In addition, the guide is alternatively or additionally formed by a through-opening in the retaining element 44, through which a projection 54 extends, which engages with the first rod element 20 in the locking position. This through-opening is clearly visible in FIGS. 7 and 8. The locking device 40 is designed to provide a first latched position for the locking element 42 when in its locking position and a second latched position for the locking element 42 when in its release position. For this purpose, the retaining element 44 has three grooves 48 on two opposite sides, each facing away from the second rod element 22 and thus facing the locking element 42. In addition, the locking element 42 has two projections 50 on two opposite sides, the shape of each of which corresponds to the grooves 48 and which face the retaining element 44. In the locking position and in the release position, these projections 50 each engage in two of the three grooves 48 and thus retain the locking element 42 in position. When latching occurs, an audible latching sound occurs.

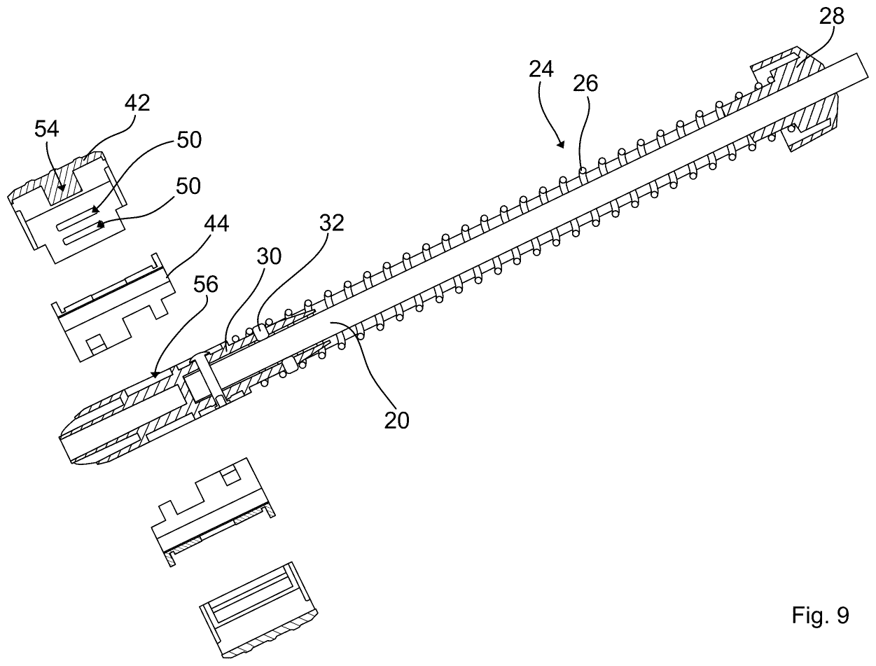

As can be seen, for example, in FIG. 7 to 9, the locking element 42 is made up of two parts. These two parts of the locking element 42 are connected to one another by a snap-fit connection and surround the retaining element 44 in the circumferential direction. Likewise, the retaining element 44 is made up of two parts. These two parts of the retaining element 44 are connected to one another by a snap-fit connection and surround the second rod element 22 in the circumferential direction.

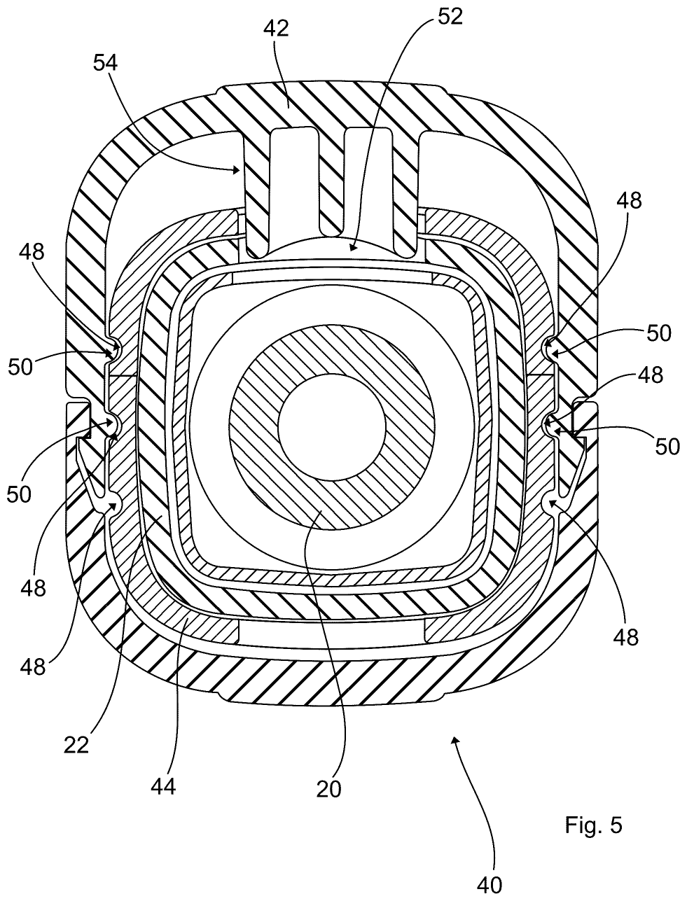

As can be seen in FIG. 5 to 7, the second rod element 22 has a through-opening 52 in the side of its wall. The locking device 40 is held at this through-opening 52. For this purpose, in the first embodiment the projection 54 of the locking element 42 protrudes into the through-opening 52 both in the release position and in the locking position.

In the locking position, the projection 54 engages in a groove 56 of the first rod element 20 extending in the circumferential direction, which groove is made in the further bearing element 30. This circumferential groove 56 can be seen particularly well in FIG. 8. As a result, the locking element 42 only blocks a movement of the first rod element 20 relative to the second rod element 22 in the axial direction. As a result of the circumferential groove 56, the first rod element 20 is held on the second rod element 22 so as to be rotatable about its axial extent in both the locking state and the release state.

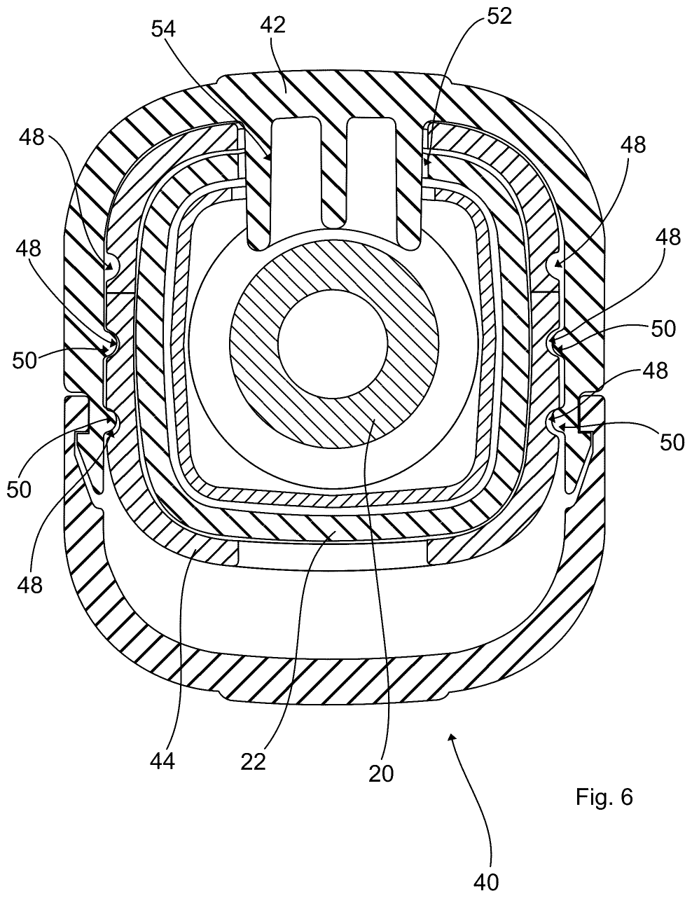

The projection 54 has slight axial play in the groove 56. In order to avoid a loud noise when the projection 54 strikes the further bearing element 30 when pulling the trailer 10, the locking device 40 has damping elements. The projection 54 is slotted, with three wall regions forming two retaining slots. This can be seen particularly well in FIG. 6. In each of these two retaining slots there sits one of the damping elements, which is made of a softer material than the rest of the locking element 42. This results in less noise when striking the walls of the groove 56. The damping elements are thus held on a side of the locking element 42 that faces the first rod element 20. The locking element 42 only engages with the first rod element 20 by means of the damping elements in the locking position. In another embodiment, the damping elements are omitted and the locking element 42 engages directly with the further bearing element 30 and thus the first rod element 20 in its locking position.

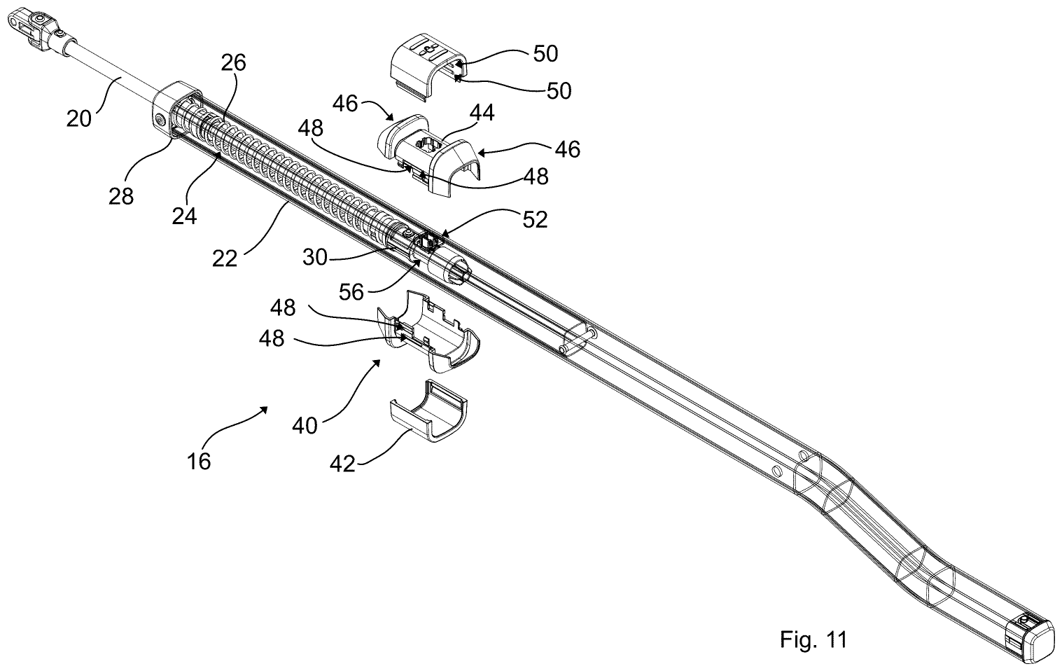

FIG. 11 to 14 show a second embodiment of the pulling device 16. Only differences shall be explained below.

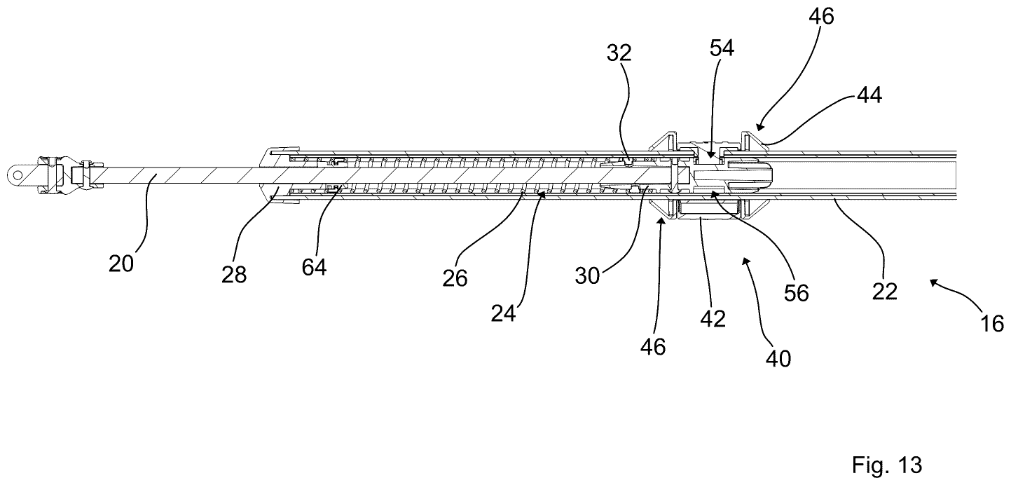

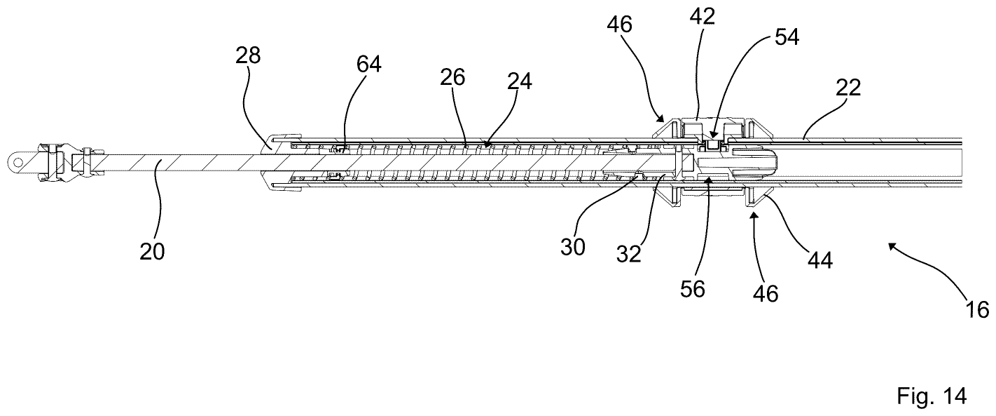

In the second embodiment, the retaining element 44 also forms a guide for the locking element 42 through two circumferential walls 46 which are formed at axially opposite ends of the retaining element 44. These walls 46 are beveled on their sides facing axially away from the locking element 42. This reduces the risk of the locking device 40 getting caught on obstacles. In addition, the walls 46 are high enough that an actuating side of the locking element 42 is aligned with the guide or with an upper edge of the walls 46 so as to be flush therewith in the locking position. Likewise, in the release position, an opposite actuating side of the locking element 42 is aligned with the guide so as to be flush therewith. This reduces the risk of unintentional actuation of the locking element 42. In addition, a space formed in each of the two positions on opposite sides between the locking element 42 and the retaining element 44 is axially laterally closed by the walls 46, which can be clearly seen in FIGS. 13 and 14. As a result, this space and also the locking device 40 as a whole are effectively sealed against the ingress of snow. In addition, this also reliably prevents snow from entering the through-opening 52 in the second rod element 22.

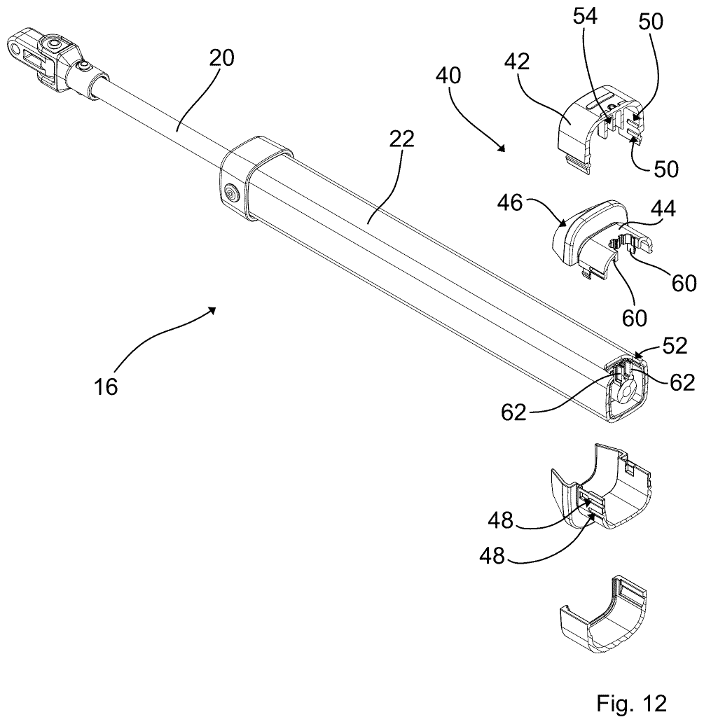

In addition, in the second embodiment, the locking device 40 is held in a different manner at the through-opening 52 of the second rod element 22. As can be seen in particular in FIG. 12, the retaining element 44 has two projections 60 which protrude into the through-opening 52 of the second rod element 22. These projections 60 form a clip connection with the wall of the second rod element 22 and thus fix the locking device 40 to the second rod element 22.

In FIG. 12, two damping elements 62 are also shown, which have already been described for the first embodiment. In addition, the bearing element 28 has a further guide 64 similar to the guide 32 on the further bearing element 30, by means of which the spring element 26 is also rotatably mounted on the further bearing element 30. This can be seen in particular in FIG. 13. As a result, tensioning of the spring element 26 is even more reliably prevented when the first rod element 20 rotates about its longitudinal extent relative to the second rod element 22.

### LIST OF REFERENCE NUMERALS

10 Trailer
12 Frame structure
14 Skis
16 Towing device
18 Back plate
20 First rod element
22 Second rod element
24 Spring device
26 Spring element
28 Bearing element
30 Additional bearing element
32 Guide
40 Locking device
42 Locking element
44 Holding element
46 Wall
48 Groove
50 Projection
52 Lateral through-opening of the second rod element
54 Projection
56 Groove
60 Projection
62 Damping element
64 Further guide

1-13. (canceled)

14. A trailer towing device comprising:
a spring device; and
a locking device,
wherein the locking device is configured to move between a locking state in which the spring device is blocked and a release state.

15. The towing device of claim 14, wherein the towing device comprises a first rod element and a second rod element, wherein the first rod element is mounted on the second rod element, wherein the first rod element is configured to translate along a longitudinal axis extending through the second rod element, and wherein the spring device is configured to resist translation of the first rod element.

16. The towing device of claim 15, wherein the locking device is configured to secure the first rod element to the second rod element in the locking state.

17. The towing device of claim 15, wherein the locking device comprises a locking element configured to attach to the second rod element, and configured to move between a locking position in which the locking element engages the first rod element and a release position.

18. The towing device of claim 17, wherein the locking element is configured to move in a direction transverse to a longitudinal axis extending through the first rod element.

19. The towing device of claim 15, wherein the locking device comprises a retaining element configured to secure the locking element to the second rod element in an axially fixed position.

20. The towing device of claim 16, wherein the locking device is configured to secure the locking element in a first latched position in the locking position, or configured to secure the locking element in a second latched position in the release position.

21. The towing device of claim 17, wherein the locking device comprises a damping element configured to engage the first rod in the locking position.

22. The towing device of claim 21, wherein the damping element is disposed on a side of the locking element that faces the first rod element, and wherein the damping element connects the locking element to the first rod element in the locking position.

23. The towing device of claim 19, wherein the retaining element forms a guide for the locking element, wherein an actuating side of the locking element aligns with the guide and is flush with the guide in the locking position, and wherein the actuating side of the locking element aligns with the guide and is flush with the guide in the release position.

24. The towing device of claim 19, wherein the locking element comprises a first part and a second part, and wherein the first part and the second part are configured to connect to each other by a snap-fit connection.

25. The towing device of claim 24, wherein the first part and the second part are configured to surround the second rod element or the retaining element.

26. The towing device of claim 19, wherein the retaining element comprises a first part and a second part, and wherein the first part and the second part are configured to connect to each other by a snap-fit connection.

27. The towing device of claim 26, wherein the first part and the second part are configured to surround the second rod element.

28. The towing device of claim 15, wherein the locking element comprises a protrusion protruding into an opening disposed in the second rod element in the engagement position and in the release position, and wherein the protrusion is configured to secure the locking device in the opening.

29. The towing device of claim 28, wherein the retaining element comprises a protrusion protruding into an opening disposed in the second rod element, and wherein the protrusion is configured to secure the locking device in the opening.

30. The towing device of claim 15, wherein the first rod element is configured to rotate about a longitudinal axis of the second rod element in the release state, and wherein the first rod element is configured to rotate about a longitudinal axis of the second rod element in the locking state.

31. The towing device of claim 17, wherein the opening of the second rod element is sealed.

32. A trailer pulling system, comprising:
a towing device comprising a spring device and a locking device,
wherein the locking device is configured to move between a locking state and a release state, and
wherein the trailer pulling system is configured to be pulled by a cross-country skier.
